(19) United States
(12) Patent Application Publication
(10) Pub. No.: US 2023/0232073 A1
(43) Pub. Date: Jul. 20, 2023

(54) MEDIA DEVICE HOUSEHOLDING AND DEDUPLICATION

(71) Applicant: The Nielsen Company (US), LLC, New York, NY (US)

(72) Inventors: Samantha M. Mowrer, La Grange, IL (US); David J. Kurzynski, Elgin, IL (US); Kevin Li, Brooklyn, NY (US); Joshua Edward Morgan, Chicago, IL (US); Zack Zofrea, St. Petersburg, FL (US)

(21) Appl. No.: 17/902,645

(22) Filed: Sep. 2, 2022

Related U.S. Application Data
(60) Provisional application No. 63/300,626, filed on Jan. 18, 2022.

(51) Int. Cl. H04N 21/45; G06F 16/215

(52) U.S. Cl. CPC H04N 21/4532; H04N 21/4516; G06F 16/215

(57) ABSTRACT

Methods, apparatus, systems, and articles of manufacture are disclosed. An apparatus includes at least one memory, instructions, and processor circuitry to execute the instructions. The processor circuitry executes the instructions to deduplicate at least one of panel data, automatic content recognition data, or return path data to generate a deduplicated data set. The processor circuitry executes the instructions to generate a graph that connects devices identified in the deduplicated data set, the devices connected based on at least one of a shared intemet protocol addresses, a shared location identifier, or a common device identifier assigned by a common device identification algorithm. The processor circuitry executes the instructions to remove one or more connections based on an inconsistency between the one or more connections and personally identifiable information.

### RELATED APPLICATION

This patent claims the benefit of U.S. Provisional Patent Application No. 63/300,626, which was filed on Jan. 18, 2022. U.S. Provisional Patent Application No. 63/300,626 is hereby incorporated herein by reference in its entirety. Priority to U.S. Provisional Patent Application No. 63/300,626 is hereby claimed.

### FIELD OF THE DISCLOSURE

This disclosure relates generally to audience measurement and, more particularly, to media device householding and deduplication for audience measurement.

### BACKGROUND

Media is accessible to users through a variety of platforms. Media can be viewed on television sets, via the Internet, on mobile devices, in-home, out-of-home, live, time-shifted, etc. Media providers seek to understand consumer-based engagement with media to increase user engagement with the media.

### BRIEF DESCRIPTION OF THE DRAWINGS

FIG. 1 is an example illustration of a system for deduplication and householding of devices.

FIG. 2 is a block diagram of example householding circuitry.

FIG. 3 is an example illustration of householding circuitry to household output based on provider data.

FIG. 4 is an illustration of example deduplication circuitry to deduplicate raw data.

FIG. 5 is an illustration of example graph generation circuitry to generate a graph from deduplicated data.

FIG. 6 is an illustration of example connected component circuitry to identify connected component(s) in a graph.

FIG. 7 is an example table that includes output generated by householding circuitry.

FIG. 8 is a flowchart representative of example machine readable instructions and/or example operations that may be executed by example processor circuitry to implement the householding circuitry of FIG. 2.

FIG. 9 is a flowchart representative of example machine readable instructions and/or example operations that may be executed by example processor circuitry to deduplicate device data.

FIG. 10 is a flowchart representative of example machine readable instructions and/or example operations that may be executed by example processor circuitry to prune a household graph.

FIG. 11 is a block diagram of an example processing platform including processor circuitry structured to execute the example machine readable instructions and/or the example operations of FIGS. 6-8 to implement the householding circuitry 108 of FIG. 2.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 8-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, the terms “media,” “media content,” and/or “media presentation” include any type of content and/or advertisement delivered via any type of distribution medium. Thus, media includes television programming or advertisements, radio programming or advertisements, movies, web sites, streaming media, etc.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

As used herein, the terms “media,” “media content,” and/or “media presentation” include any type of content and/or advertisement delivered via any type of distribution medium. Thus, media includes television programming or advertisements, radio programming or advertisements, movies, web sites, streaming media, etc.

### DETAILED DESCRIPTION

As media exposure becomes increasingly fragmented across devices, platforms, and services, audience measurement entities (AME) are working to utilize a wider variety of data sources in television (TV) audience measurement. While statistical panels remain the gold standard, other datasets can provide additional information to improve measurement. For example, set-top box and smart TV data can stabilize estimates and mitigate sampling error. However, these data sources are of varying levels of quality and each may have unique challenges based on the techniques through which they collect audience measurement data. Further, as data from the same device may appear in multiple sources, deduplication may be desired to avoid double counting devices in the final audience measurement or ratings data. Deduplication is a process that adjusts device totals by reducing double counting of devices present in more than one source of data.

Some data sources may include detailed information related to a household and devices associated with the household. For example, complete information on a home, its inhabitants, and media devices within the home may be directly measured when a home is a panelist household. A panelist household is a household that cooperates in an audience measurement study. In some examples, media consumption habits and demographic data associated with enlisted panelists are collected and used to statistically determine the size and demographics of the entire audience of the media presentation.

Non-panelist data sources may lack complete household information. In some cases, only device-level information is available that provides no information about connections between devices. Some data sources only include media activity at a particular home, at a particular IP address, or for a single unique device. Some data sources may contain individual media presentation events that are not linked to any other events.

Examples disclosed herein identify unique devices from disparate sets of data and group the unique devices into households. To identify unique devices, examples disclosed herein unify data from panelist data, big data, multichannel video programming distributors (MVPDs), and internet-connected smart TVs.

Disclosed examples use subscriber information, IP addresses, third-party identifiers, and other algorithms to household and/or deduplicate devices. Media providers often obtain personally identifiable information (PII) of their subscribers. Therefore, return path data (RPD) provided by media providers can help establish a household graph that includes household and geolocation information. Some examples include transient information (e.g., IP address, Wi-Fi positioning, GPS data, etc.) that supplements trusted information (e.g., panelist data). Furthermore, linear TV tuning may provide additional behavioral information that can be used to directly link and deduplicate devices across sources.

In some examples, information that links devices together is represented in a graph to which a community detection method is applied. The community detection method defines clusters of devices as households (e.g., communities). A pruning process breaks up groups that are inconsistent to arrive at final deduplicated household assignment.

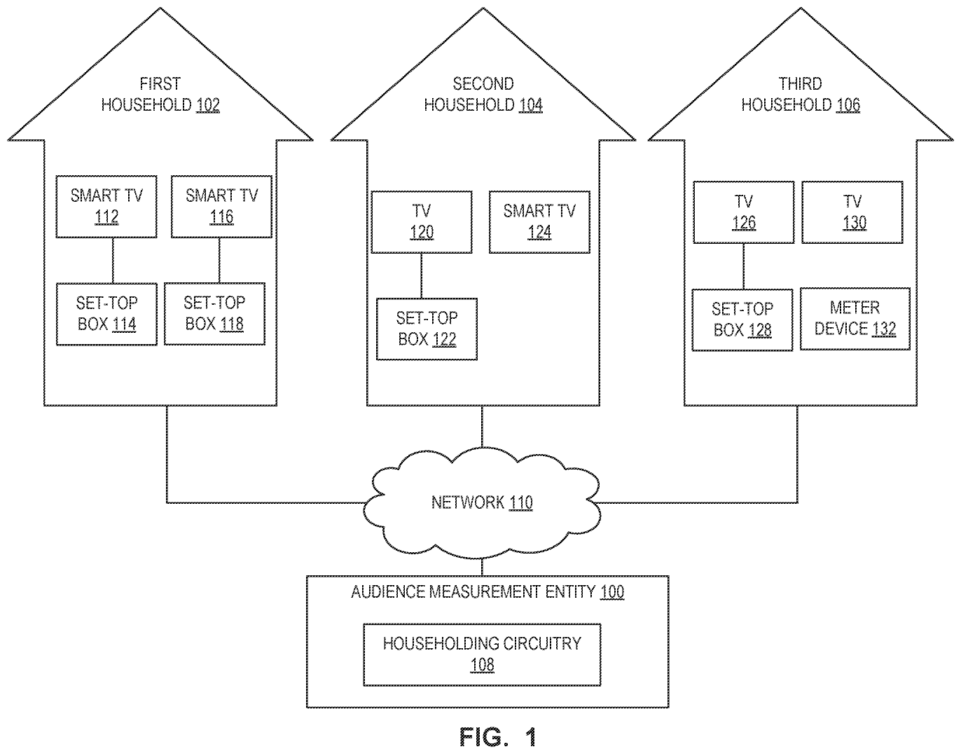

Turning to the figures, FIG. 1 is an illustration of example households with associated devices. The illustration of FIG. 1 includes an example audience measurement entity 100, an example first household 102, an example second household 104, an example third household 106, example householding circuitry 108, and an example network 110.

The example first household 102 includes a first smart TV 112, a first set-top box 114, a second smart TV 116, and a second set-top box 118. The example first smart TV 112 is an internet-connected, automatic content recognition (ACR) capable television that provides information at a device level. Thus, the first smart TV 112 provides media access data without providing information that links the first smart TV 112 to other devices within the first household 102. For example, the first smart TV 112 may include the capability to identify media playing on the first smart TV 112 and transmit that data to the AME 100 that operates the householding circuitry 108.

The AME 100 also obtains data from the first set-top box 114 and the second set-top box 118. Return path capable set-top boxes such as the first set-top box 114 and the second set-top box 118 can store media exposure information and return that information to the AME 100. In the first household. 102, the first smart TV 112 is connected to the first set-top box 114. Yet, the first smart TV 112 and the first set-top box 114 may be associated with two different media providers and therefore provide duplicate identifying data to the AME 100 for the first smart TV 112. As used herein, a media provider may be any entity that is associated with media consumption. For example, a media provider may be a set-top box operator (e.g., a digital cable box operator), a television manufacturer e.g., a smart TV manufacturer), an audience measurement entity, etc.

For example, the first smart TV 112 may transmit ACR data to a first media provider, and the first set-top box 114 may transmit RPD to a second media provider. Each of the first and second providers may provide data to the AME 100 without including information identifying a linkage between the first smart TV 112 and the first set-top box 114. Thus, the AME 100 receives information that includes duplicate information for the first smart TV 112.

The example first household 102 includes the second smart TV 116 that is connected to the second set-top box 118. The second smart TV 116 is associated with a third media provider. The second set-top box 118 is associated with a second media provider. Therefore, the AME 100 may receive information from both the second and the third media providers (e.g., duplicative tuning information) for the second smart TV 116: once from RPD for the second set-top box 118 and a second time from ACR from the second smart TV 116.

The example second household 104 includes a first traditional TV 120. The first traditional TV 120 displays linear programming provided by a third media provider, based on the third set-top box 122. Linear television is television programming that follows a schedule that is determined by a media provider or another media entity. In contrast, non-linear programming is media that follows a schedule determined by a user (e.g., on-demand programming). As the first traditional TV 120 does not have smart TV capabilities (e.g., ACR), information identifying the first traditional TV 120 is only provided to an audience measurement entity by the third set-top box 122. The third set-top box 122 is associated with a third media provider.

The example second household 104 further includes the third smart TV 124. The third smart TV 124 is associated with the first media provider. Therefore, an audience measurement entity that collects data for the second household 104 may receive RPD from the third set-top box 122 (e.g., via the third media provider) and ACR data from the third smart TV 124, without receiving information that identifies the first traditional TV 120 and the third smart TV 124 as being in the same household.

The example third household 106 is a panelist household that has enrolled with the AME 100. The panelist household has agreed to provide media consumption information, device information, and/or other PII to the AME 100. The example third household 106 includes a second traditional TV 126 that is connected to a fourth set-top box 128. The fourth set-top box 128 is associated with a third media provider that provides data to the AME 100. The third household 106 further includes a third traditional TV 130 that is monitored based on a meter device 132 that returns data to the AME 100.

Data from the first household 102, the second household 104, and the third household 106 is provided to the AME 100 via network 110. The network 110 is the Internet. However, in some examples the network 110 may be a local area network, a wide area network, etc.

The example householding circuity 108 integrates and deduplicates the data generated by the first household 102, the second household 104. and the third household 106. Thus, the example householding circuitry 108 ingests data from multiple sources (e.g., the first media provider, the second media provider, the third media provider, and panelists). As the data streams are not mutually exclusive, the householding circuitry 108 deduplicates the data before organizing the data into households. The deduplication allows consistent assignment of demographics for devices within the same household.

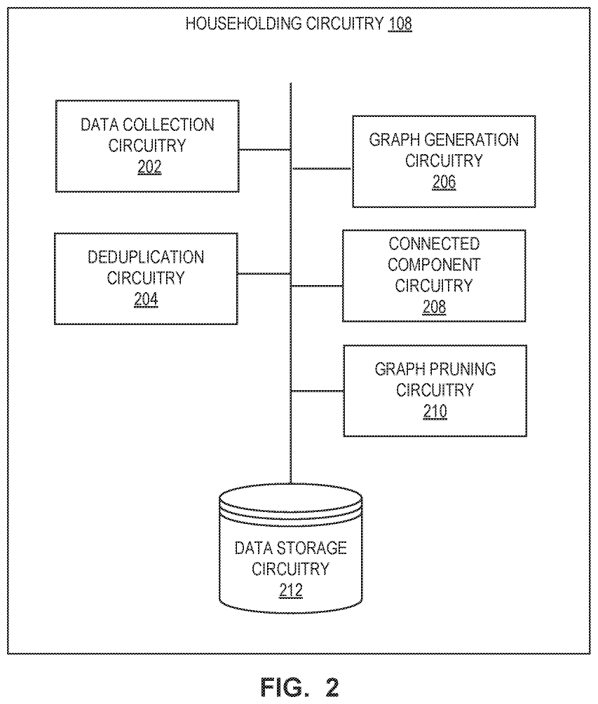

Examples disclosed herein combine information collected from connected TVs, mobile, and other digital platforms and provided to the AME 100. Some examples deduplicate and household devices based on linear TV with addressable ad insertion and connected TV data. In examples that have access to robust panel data (e.g., panelist household data, meter data, etc.), a complete measurement of households can be produced. Examples with robust panelist data may also be used as a validation set. The structure and operation of the householding circuitry will be described in FIGS. 2-6.

FIG. 2 is a block diagram of example householding circuitry 108 to deduplicate and household media devices. The householding circuitry 108 of FIG. 2 may be instantiated (e.g., creating an instance of, bring into being for any length of time, materialize, implement, etc.) by processor circuitry such as a central processing unit executing instructions. Additionally or alternatively, the householding circuitry 108 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The example householding circuitry 108 includes data collection circuitry 202. The data collection circuitry 202 collects data (e.g., retrieves data, requests data, etc.) from media providers, media entities, devices, and/or AMEs that monitor media consumption. The data collection circuitry 202 may retrieve data from a plurality of media providers.

Data retrieved from the data collection circuitry 202 may include tuning information from media providers (e.g., what channel is being watched, how long the channel is watched, etc.). In some examples, a home with multiple devices produces tuning data that is collected by multiple different media providers. This device-level tuning data may be provided to an audience measurement entity without being separated by provider.

Data collected by the data collection circuitry 202 may include information from internet service providers. The information may be, for example, IP address information and/or internet usage information from a household. In some examples, the data collection circuitry may collect and/or receive PII and or other household information to link devices to a household. For example, PII used to deduplicate devices and/or link devices as being in a household may include public records, tax assessor records, motor vehicle information, census data, publication subscription information, credit information, consumer surveys, etc.

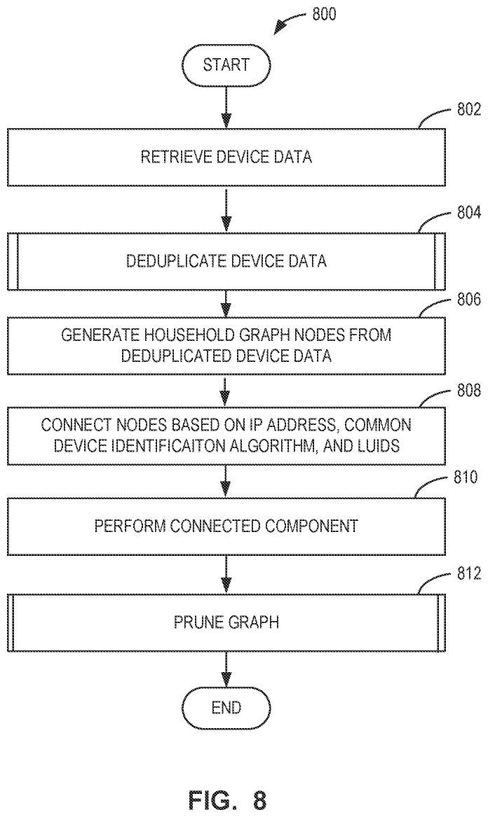

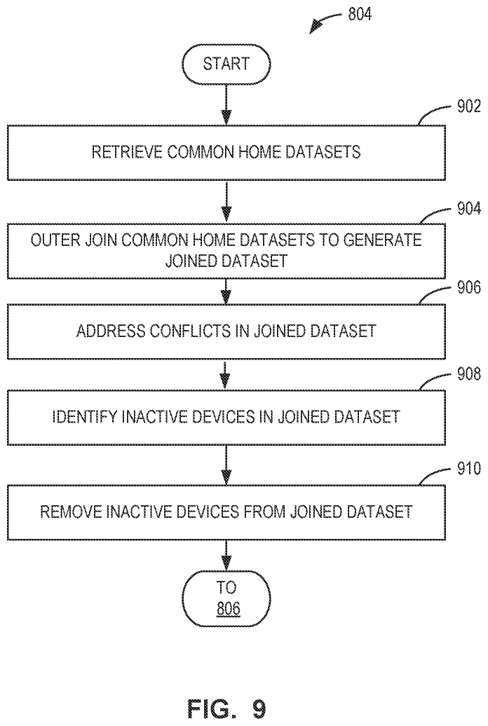

In some examples, the data collection circuitry 202 is instantiated by processor circuitry executing data collection instructions and/or configured to perform operations such as those represented by the flowcharts of FIGS. 8-9.

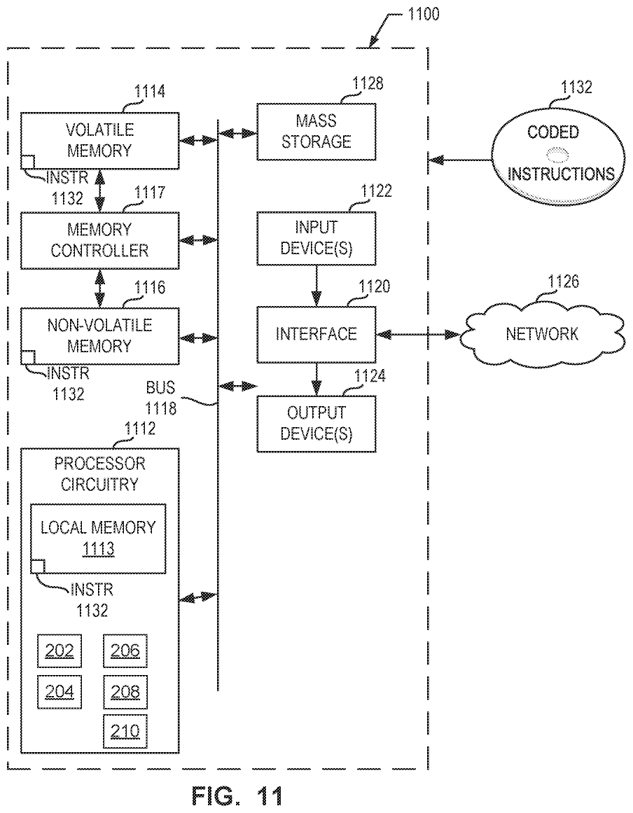

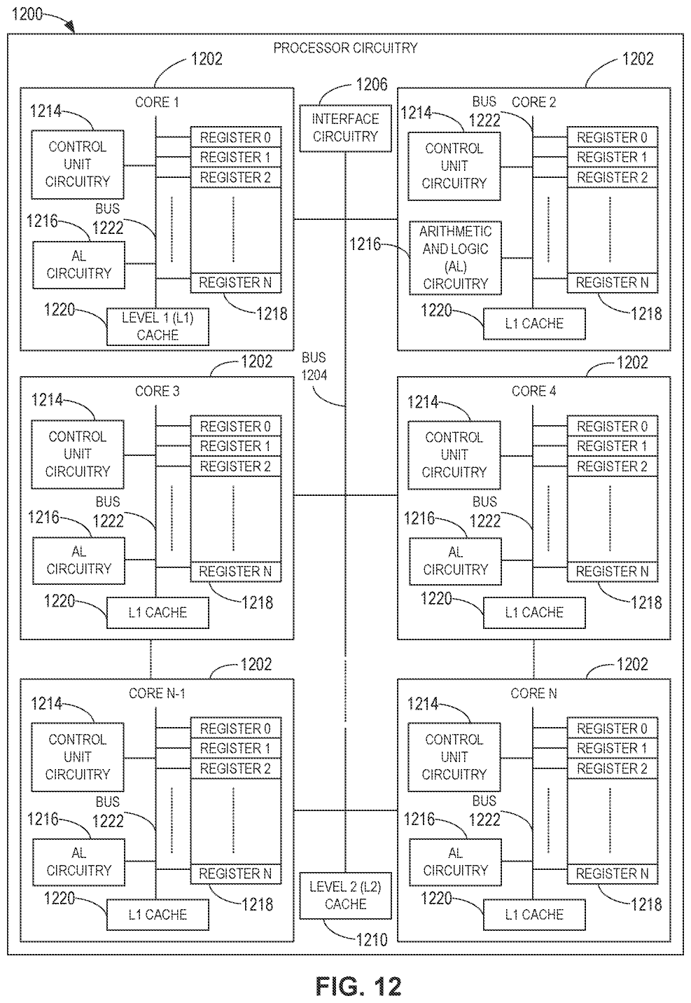

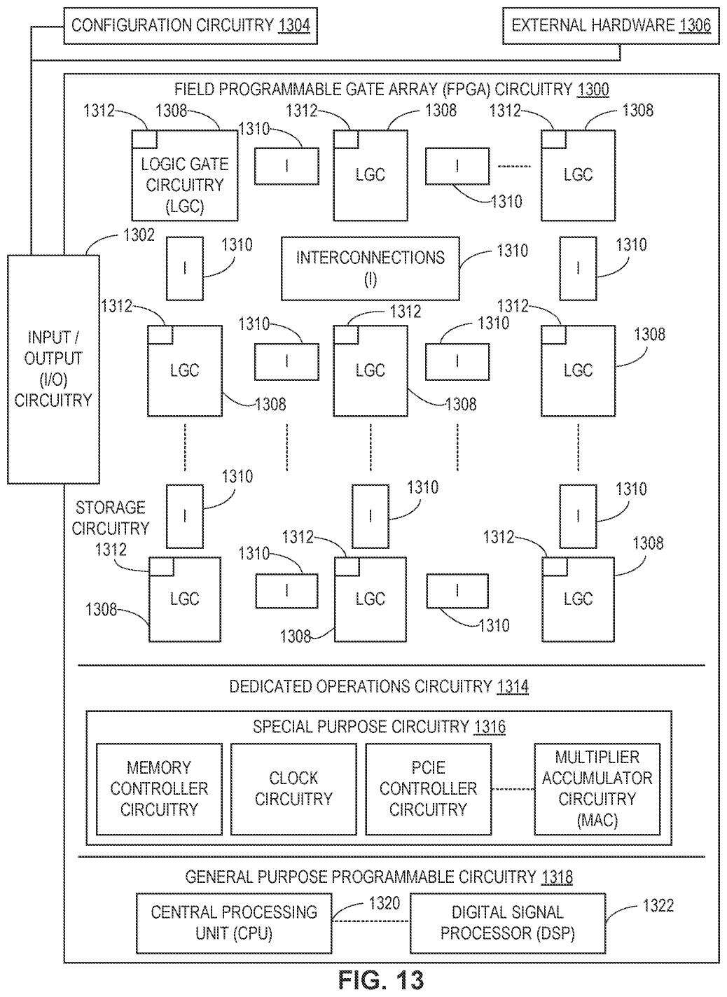

In some examples, the householding circuitry 108 includes means for retrieving data from a plurality of sources. For example, the means for retrieving data from a plurality of sources may be implemented by data collection circuitry 202. In some examples, the data collection circuitry 202 may be instantiated by processor circuitry such as the example processor circuitry 1112 of FIG. 11. For instance, the data collection circuitry 202 may be instantiated by the example microprocessor 1200 of FIG. 12 executing machine executable instructions such as those implemented by at least blocks 802 of FIG. 8, 902 of FIG. 9. In some examples, the data collection circuitry 202 may be instantiated by hardware logic circuitry, which may be implemented by an ASIC, XPU, or the FPGA circuitry 1300 of FIG. 13 structured to perform operations corresponding to the machine readable instructions. Additionally or alternatively, the data collection circuitry 202 may be instantiated by any other combination of hardware, software, and/or firmware. For example, the data collection circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example householding circuitry 108 includes example deduplication circuitry 204. The deduplication circuitry 204 retrieves data provided by the data collection circuitry 202 and identifies devices that are duplicated across datasets. The deduplication circuitry 204 may use any combination of information about households, subscriber information, IP address, third-party identifiers, and a common devices identification algorithm to identify duplicated devices present in multiple data sources.

In some examples, the audience measurement entity may use a common devices identification algorithm that identifies and deduplicates devices based on one or more data. The one or more data may include tuning behavior across datasets, media presentation information (e.g., channel/station identifiers, program identifiers, etc.), timing and sequencing of tuning events, duration of tuning events, etc. Such data can be optimized based on known qualities of the data sources under evaluation. In some examples, the data collection circuitry 202 gathers information across devices for a threshold period. The threshold period may be based on the data provider.

In some examples, deduplication can be performed based on device-level information. For example, an audience measurement entity may use a series of unique device identifiers to deduplicate the data (e.g., keep only one of multiple matching device serial numbers). In some examples, an audience measurement entity does not have unique identifiers available and instead deduplicates based on a combination of device data fields.

In some examples, the deduplication circuitry 204 is instantiated by processor circuitry executing deduplication instructions and/or configured to perform operations such as those represented by the flowcharts of FIGS. 8-10.

In some examples, the deduplication circuitry 204 includes means for deduplicating data across a plurality of sources. For example, the means for retrieving data from a plurality of sources may be implemented by the deduplication circuitry 204. In some examples, the deduplication circuitry 204 may be instantiated by processor circuitry such as the example processor circuitry 1112 of FIG. 11. For instance, the deduplication circuitry 204 may be instantiated by the example microprocessor 1200 of FIG. 12 executing machine executable instructions such as those implemented by at least blocks 802 of FIG. 8, 902 of FIG. 9. In some examples, the deduplication circuitry 204 may be instantiated by hardware logic circuitry, which may be implemented by an ASIC, XPU, or the FPGA circuitry 1300 of FIG. 13 structured to perform operations corresponding to the machine readable instructions. Additionally or alternatively, the deduplication circuitry 204 may be instantiated by any other combination of hardware, software, and/or firmware. For example, the deduplication circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example householding circuitry 108 includes the example graph generation circuitry 206. The graph generation circuitry 206 takes deduplicated data and third party identification data and generates a graph. The graph includes nodes that represent deduplicated devices. The nodes are connected by edges that represent linkages identified between the devices.

In some examples, an audience measurement entity only has partial data of a household. For example, the AME 100 of FIG. 1 may have RPD and STV information for a household, but not panelist information for the household. In such examples, living unit identifiers (LUID) can be used by the graph generation circuitry 206 to generate edges in a graph. For example, a home that includes many TVs for which the audience measurement entity does not have RPD data. In such examples, LUIDs may help connect the TVs to the home.

In some examples, connections are made based on addresses. The IP addresses may be filtered based on, for example, a Jaccard similarity (e.g., intersection of IP addresses, divided by the union of all IPs associated with the devices). For example, the AME 100 of FIG. 1 may identify all IP addresses associated with devices for a measurement period. Then, the AME 100 of FIG. 1 can assess a Jaccard similarity of the IP addresses between pairs of devices and set a threshold for matches. The AME 100 of FIG. 1 can then identify pairs having a similarity greater than the threshold and generate edges between the identified pairs.

The graph generation circuitry 206 may reconstruct e.g., re-generate) edges, vertices, and connected component(s) after one or more nodes (e.g., devices) are removed from the graph. The graph generation circuitry 206 may attach new components and/or remove any outlier components that are associated with an inconsistency.

In some examples, the graph generation circuitry 206 is instantiated by processor circuitry executing graph generation instructions and/or configured to perform operations such as those represented by the flowchart of FIGS. 8-10.

In some examples, the householding circuitry 108 includes means for generating a graph representing devices as nodes and device connection information as edges. For example, the means for generating a graph from a plurality of sources may be implemented by the graph generation circuitry 206. In some examples, the graph generation circuitry 206 may he instantiated by processor circuitry such as the example processor circuitry 1112 of FIG. 11. For instance, the graph generation circuitry 206 may be instantiated by the example microprocessor 1200 of FIG. 12 executing machine executable instructions such as those implemented by at least blocks 806, 808 of FIG. 8. In some examples, the graph generation circuitry 206 may be instantiated by hardware logic circuitry, which may be implemented by an ASIC, XPU, or the FPGA circuitry 1300 of FIG. 13 structured to perform operations corresponding to the machine readable instructions. Additionally or alternatively, the graph generation circuitry 206 may be instantiated by any other combination of hardware, software, and/or firmware. For example, the graph generation circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example householding circuitry 108 includes connected component circuitry 208. The connected component circuitry 208 performs a connected component analysis on a graph generated by the householding circuitry 108. The connected component analysis determines if there is one or more connected component(s) in a graph and how the component(s) are connected. The graph generated by the graph generation circuitry 206 is an undirected graph, and therefore the connected component circuitry 208 can use an undirected connected component analysis to determine connected component(s).

In some examples, the connected component circuitry 208 assigns a quality value to at least one edge in the graph, wherein the value represents how closely linked one or more devices are. Edges with quality values greater than the threshold may remain while edges with quality values less than the threshold may be removed. For example, LUIDs assigned to devices are based on PII and may be more heavily weighted (e.g., greater quality value) than LUIDs assigned to a device which is based on an IP address match (e.g., lesser quality value). In some examples, the connected component circuitry 208 performs a count of provider households/devices within each component. In some examples, the graph generation circuitry 206 is instantiated by processor circuitry executing graph generation instructions and/or configured to perform operations such as those represented by the flowchart of FIGS. 8-11.

In some examples, the connected component circuitry 208 includes means for generating a graph representing devices as nodes and device connection information as edges. For example, the means for performing a connected component analysis on a device graph may be implemented by the connected component circuitry 208. In some examples, the connected component circuitry 208 may be instantiated by processor circuitry such as the example processor circuitry 1112 of FIG. 11. For instance, the connected component circuitry 208 may be instantiated by the example microprocessor 1200 of FIG. 12 executing machine executable instructions such as those implemented by at least blocks 808 of FIG. 8. In some examples, connected component circuitry 208 may be instantiated by hardware logic circuitry, which may be implemented by an ASIC, XPU, or the FPGA circuitry 1300 of FIG. 13 structured to perform operations corresponding to the machine readable instructions. Additionally or alternatively, the connected component circuitry 208 may be instantiated by any other combination of hardware, software, and/or firmware. For example, the connected component circuitry 208 may be implemented by at least one or more hardware circuits (e.g., processor circuitry, discrete and/or integrated analog and/or digital circuitry, an FPGA, ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example householding circuitry 108 includes the example graph pruning circuitry 210. The graph pruning circuitry 210 may identify edges in the graph that are inconsistent with stored and/or received data and remove the inconsistent edges. In some examples, the graph pruning circuitry 210 identifies one or more of the following eight inconsistency types for pruning.

A first inconsistency type occurs when a common devices identification algorithm leads to multiple provider household matches for a single device. As there should be only one provider for a single device, the graph pruning circuitry 210 can prioritize higher quality data (e.g., panelist data, verified data, etc.) to ensure each device has only one provider type.

A second inconsistency type occurs when a common devices identification algorithm links a panel household with an RPD device that conflicts with a smart TV device LUID. To correct the second inconsistency, a link generated by the common devices identification algorithm can be removed.

A third inconsistency type occurs when multiple RPD households are linked due to a conflict between a common devices identification algorithm and LUIDs. For example, two devices from a first provider may share a LUID and each of the two devices may match to a second provider household. To correct the third inconsistency, IP based LUIDs can be identified as weaker than PII based LUIDs (e.g., candidates for pruning).

A fourth inconsistency type occurs when components (e.g., linked devices) with panel information contain devices that are not linked directly to a panel device. A panelist household provides detailed information on devices within the panelist household. Therefore, connecting a device through second degree links that are not associated with the panel device in the home is inconsistent. To correct the fourth inconsistency type, the example graph pruning circuitry 210 can remove all second degree connections for that component.

A fifth inconsistency type occurs when a household component contains more than one LUID. This is inconsistent given that a LUID is an identifier for a single household. To correct the fifth inconsistency type, the example graph pruning circuitry 210 can drop the relevant LUIDs.

A sixth inconsistency type occurs when a commercial establishment with more TVs than an average household is incorrectly identified as including multiple households. To correct the sixth inconsistency type, the example graph pruning circuitry 210 can identify LUIDs and IPs associated with a threshold number of smart TV devices (e.g., 10 Smart TVs).

A seventh inconsistency type occurs when data from a meter device does not align with panelist and RPD data. This may lead to an RPD and panelist household that are linked together and/or a RPD household with devices that are not directly linked to the meter device. To correct the seventh inconsistency type, the example graph pruning circuitry 210 can update the graph to pair RPD devices to a device from a panelist household.

An eighth inconsistency type occurs when a common devices identification algorithm links panelist home devices to from inconsistent provider. To correct the eighth inconsistency type, the example graph pruning circuitry 210 can remove smart TV-RPD edges within the panelist home.

In some examples, the graph pruning circuitry 210 is instantiated by processor circuitry executing graph pruning instructions and/or configured to perform operations such as those represented by the flowchart of FIGS. 8-10.

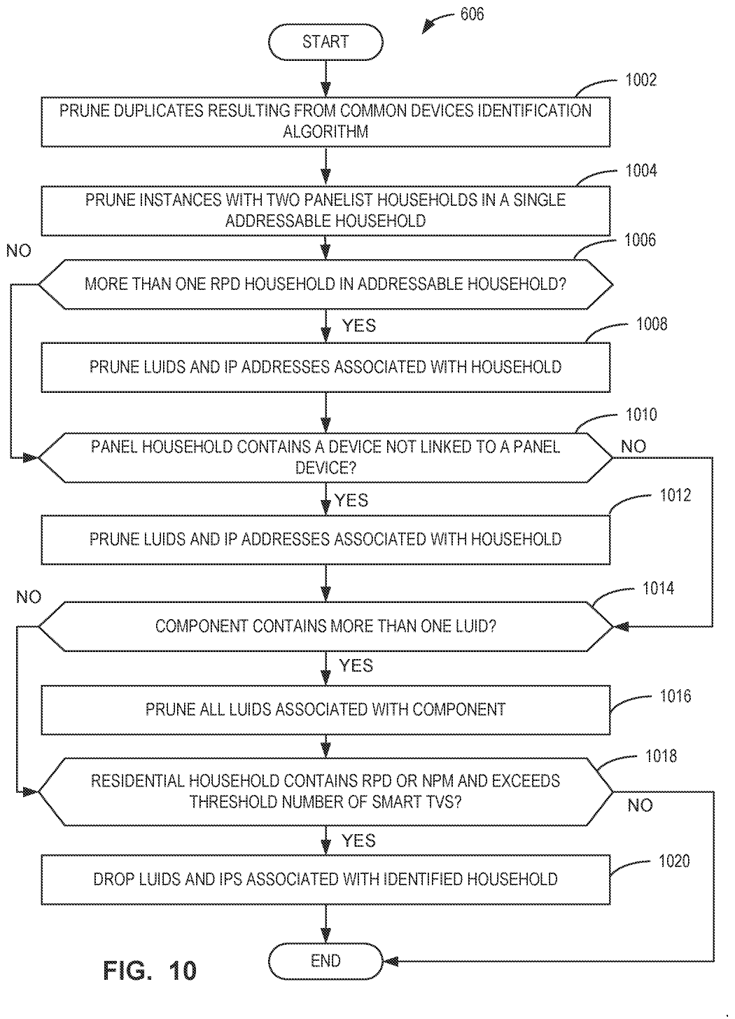

In some examples, the householding circuitry 108 includes means fix pruning a graph of inconsistent edges and/or nodes. For example, the means for pruning a graph of inconsistent edges and/or nodes may be implemented by the graph pruning circuitry 210. In some examples, the data collection circuitry 202 may be instantiated by processor circuitry such as the example processor circuitry 1112 of FIG. 11. For instance, the graph pruning circuitry 210 may be instantiated by the example microprocessor 1200 of FIG. 12 executing machine executable instructions such as those implemented by at least blocks 1002-1020 of FIG. 10. In some examples, the graph pruning circuitry 210 may be instantiated by hardware logic circuitry, which may be implemented by an ASIC, XPU, or the FPGA circuitry 1300 of FIG. 13 structured to perform operations corresponding to the machine readable instructions. Additionally or alternatively, the graph pruning circuitry 210 may be instantiated by any other combination of hardware, software, and/or firmware. For example, the graph pruning circuitry 210 may be implemented by at least one or more hardware circuits (e.g., processor circuitry, discrete and/or integrated analog and; or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example householding circuitry 108 includes the data storage circuitry 212. The data storage circuitry 212 can store data from the data collection circuitry 202. In some examples, the data storage circuitry 212 stores a graph generated by the graph pruning circuitry 210 and/or other results generated by the example data collection circuitry 202, the example deduplication circuitry 204, the example graph generation circuitry 206, the example connected component circuitry 208, and/or the example graph pruning circuitry 210.

In some examples, the data storage circuitry 212 is instantiated by processor circuitry executing data storage instructions and/or configured to perform operations such as those represented by the flowchart of FIGS. 8-10.

In some examples, the data storage circuitry 212 includes means for storing data, a graph, and/or analysis data associated with a household graph. For example, the means for storing data may be implemented by data storage circuitry 212. In some examples, the data storage circuitry 212 may be instantiated by processor circuitry such as the example processor circuitry 1112 of FIG. 11. For instance, data storage circuitry 212 may be instantiated by the example microprocessor 1200 of FIG. 12 executing machine executable instructions such as those implemented by at least blocks 802 of FIG. 8, 902 of FIG. 9. In some examples, the data storage circuitry 212 may be instantiated by hardware logic circuitry, which may be implemented by an ASIC, XPU, or the FPGA circuitry 1300 of FIG. 13 structured to perform operations corresponding to the machine readable instructions. Additionally or alternatively, the data storage circuitry 212 may be instantiated by any other combination of hardware, software, and/or firmware. For example, the data storage circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the householding circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example data collection circuitry 202, the example deduplication circuitry 204, the example graph generation circuitry 206, the example connected component circuitry 208. the example graph pruning circuitry 210, the example data storage circuitry 212, and/or, more generally, the example householding circuitry 108 of FIG. 1, may be implemented by hardware alone or by hardware in combination with software and/or firmware. Thus, for example, any of the example data collection circuitry 202, the example deduplication circuitry 204, the example graph generation circuitry 206, the example connected component circuitry 208, the example graph pruning circuitry 210, the example data storage circuitry 212, and/or, more generally, the example householding circuitry 108 of FIG. 1, could be implemented by processor circuitry, analog circuit(s), digital circuit(s), logic circuit(s), programmable processor(s), programmable microcontroller(s), graphics processing units) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example householding circuitry of FIG. 1 may include one or more elements, processes, and/or devices in addition to, or instead of, those illustrated in FIG. 2, and/or may include more than one of any or all of the illustrated elements, processes and devices.

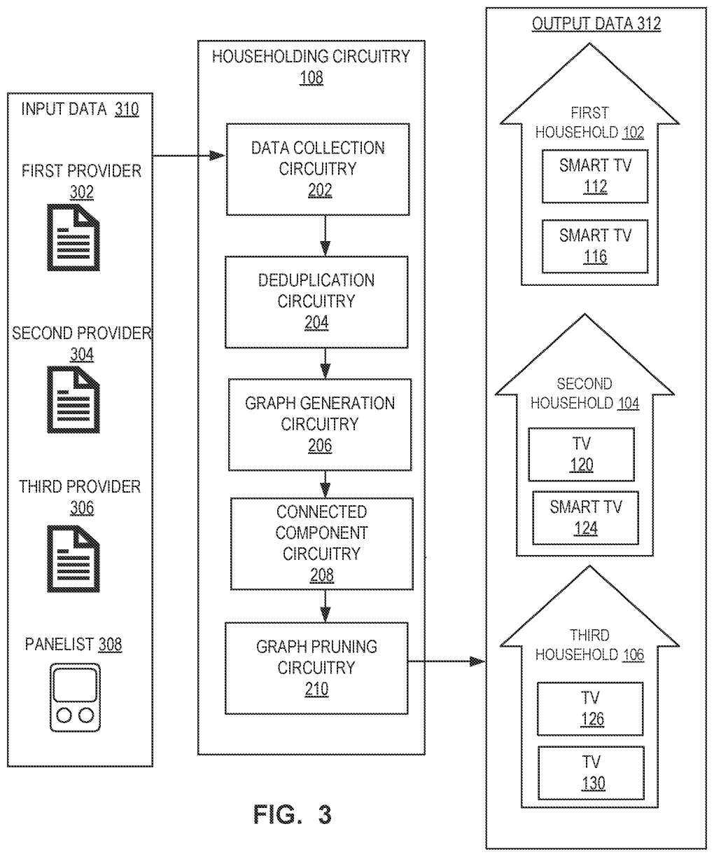

FIG. 3 is an example block diagram illustrating input data being operated on by the householding circuitry 108. The illustration of FIG. 3 includes input data 310, a first provider 302, a second provider 304, a third provider 306, a panelist 308, the householding circuity 108, the data collection circuitry 202, the graph generation circuitry 206, the connected component circuitry 208, the graph pruning circuitry 210, output data 312, the first household 102, the first smart TV 112, the second smart TV 116, the second household 104, the first traditional TV 120 the third smart TV 124, the third household 106, the second traditional TV 126, and the third traditional TV 130.

FIG. 3 illustrates an example flow of data through the householding circuitry 108. The input data includes data from a plurality of providers: the first provider 302, the second provider 304, the third provider 306, and the panelist 308. The data from the plurality of providers is transmitted to the householding circuitry 108. Specifically, the data collection circuitry 202 retrieves the input data 310 and transmits the input data 310 to the deduplication circuitry 204.

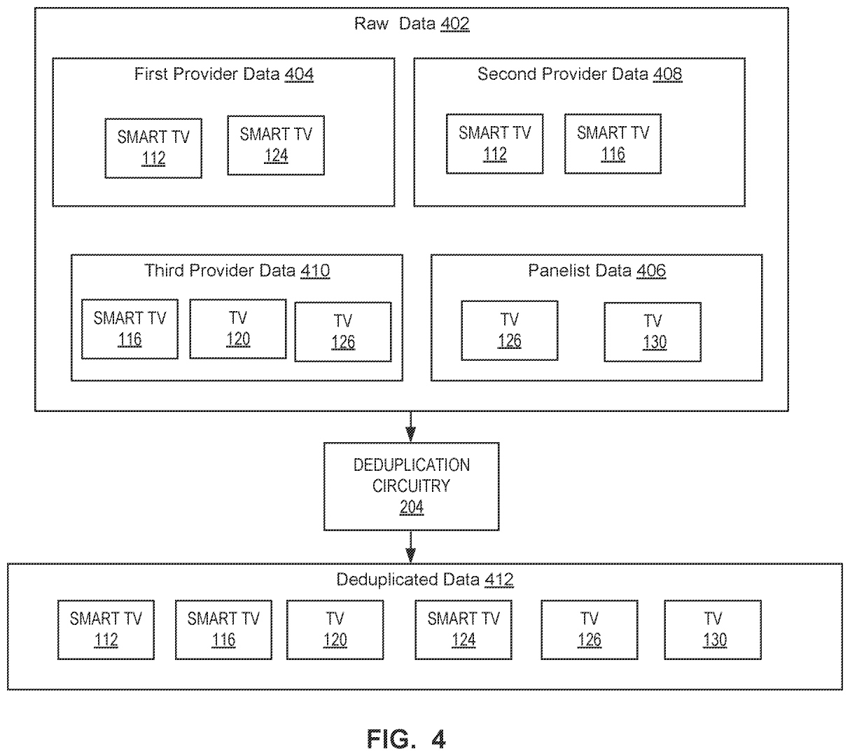

The example householding circuitry 108 ingests data from multiple sources. As the data streams are not mutually exclusive, the data must be deduplicated and organized into households. As described in relation to FIG. 1, various TVs in different households may be present across different data sources. For example, the first provider 302 and the second provider 304 may both include the first smart TV 112 in their data sets. The deduplication circuitry 204 takes the data and removes duplicates from the data. An example of data deduplication will be described in association with FIG. 4.

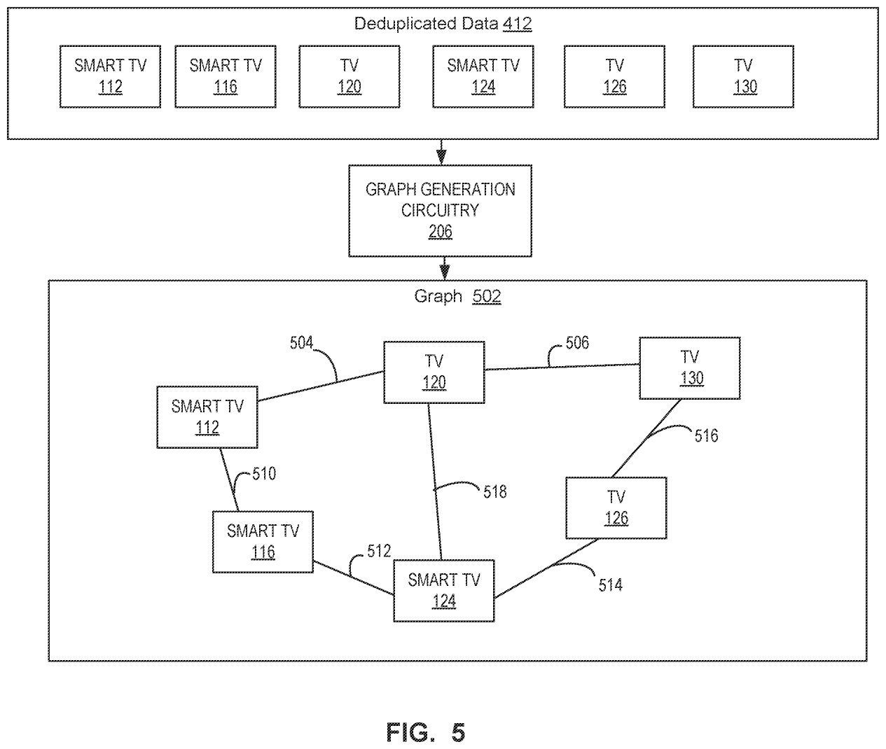

The graph generation circuitry 206 obtains data from the deduplication circuitry 204 and generates a graph from the data used to household devices. An example of graph generation will be described in association with FIG. 5. The graph is next transmitted to the connected component circuitry 208. The connected component circuitry 208 performs a connected component analysis on the graph and determines which devices are strongly connected (e.g., intra-household connections) and which devices are weakly connected (e.g., inter-household connections).

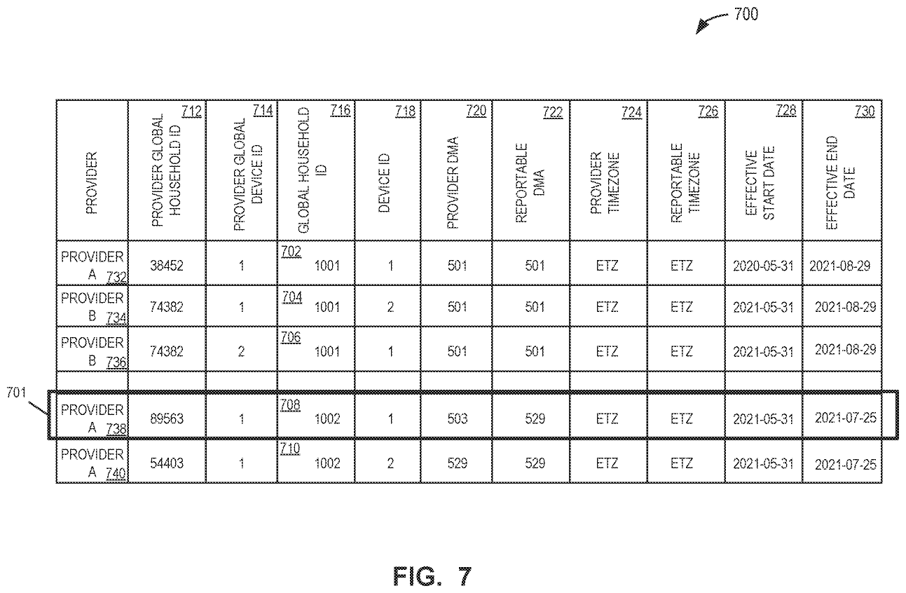

Next, the graph pruning circuitry 210 obtains, from the connected component circuitry 208, a graph that includes an initial identification of households. The graph pruning circuitry 210 further analyzes the graph for inconsistent devices and/or inconsistent connections between devices and removes the inconsistencies. The graph pruning circuitry 210 and/or the connected component circuitry 208 may reconstruct the graph after components of the graph are removed and/or rearranged. The graph pruning circuitry 210 then generates a finalized output. The output data may be in the m of a table, as illustrated in FIG. 7.

FIG. 4 is an illustration of example raw data 402 being deduplicated by the deduplication circuitry 204 of FIG. 2. The example raw data 402 includes first provider data 404, second provider data 408, third provider data 410, and panelist data 406. Notably, various TVs within the raw data are duplicated. For example, the first smart TV 112 of the first media provider appears in both the first provider data 404 and the second provider data 408. The second smart TV 116 appears in the third provider data 410 and the second provider data 408.

Not all data is duplicative, however. The first traditional TV 120 only appears in the third provider data 410, as the first traditional TV 120 does not include smart TV capabilities and therefore only RPD data of an associated set-top box is provided to the AME 100 of FIG. 1. The raw data 402 is provided to the deduplication circuitry 204, which generates a deduplicated output. The deduplicated data 412 includes only one instance of each device included in the raw data 402.

FIG. 5 is an example illustration of the graph generation circuitry 206 generating a graph from the deduplicated data 412. The deduplicated data 412 is obtained by the graph generation circuitry 206.

Devices of the deduplicated data 412 are represented as nodes in an example graph 502. The nodes are then connected based on data obtained by the audience measurement entity 100 of FIG. 1 (e.g., IP addresses, LUIDs, RPD data, etc.). The example graph includes a first edge 504 between the first traditional TV 120 and the first smart TV 112. As illustrated in FIG. 1, the example first smart TV 112 is a member of the first household 102 and the example first traditional TV 120 is a member of the second household 104. Therefore, the audience measurement entity 102 has received data linking the first traditional TV 120 to the first smart TV 112, despite the fact that the first traditional TV 120 and the first smart TV 112 are in separate households.

The AME 100 of FIG. 1 obtains additional data connecting devices between households. An example second edge 506 connects the first traditional TV 120 to the third traditional TV 130. The third traditional TV 130 and the first traditional TV 120 are members of different households. An example fourth edge 512 and an example fifth edge 514 are also inter-household edges.

An example third edge 510 connects the first smart TV 112 and the second smart TV 116. The first smart TV 112 and the second smart TV 116 are both members of the same household, and therefore this is an intra-household connection (e.g., a strong connection). A sixth edge 516 and a seventh edge 518 are additional intra-household connections that are identified by the graph generation circuitry 206.

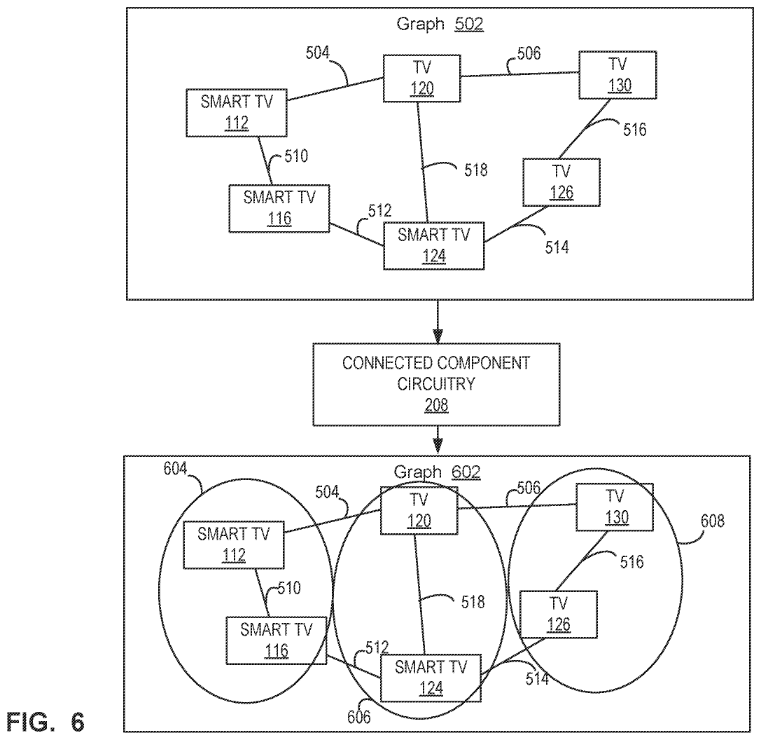

FIG. 6 is an example illustration of the connected component circuitry 208 that has identified connected components in a graph 602. The example connected component circuitry 208 identifies connections based a connected component algorithm. The first smart TV 112 and the second smart TV 116 are identified as being in a household as illustrated by the first strongly connected components identifier 604. The first traditional TV 120 and the third smart TV 124 are identified as being in a household as illustrated by the second strongly connected components identifier 606. The second strongly connected components identifier 606 indicates that the first traditional TV 120 is strongly connected to the third smart TV 124. The third strongly connected components identifier 608 indicates that the second traditional TV 126 is strongly connected to the third traditional TV 130.

The example household graph 602 includes six devices that are all connected. Some devices are strongly connected (e.g., connected by edges 510, 518, 516). Some devices are weakly connected (e.g., connected by edges 506, 512, 514). However, in some examples, the household graph 602 may include devices without data linkages. In such an example, the device without linkage information can be represented in the graph without linkages (e.g., single device, an island in the graph).

FIG. 7 is an example output of the householding circuitry 108, The example householding circuitry 108 may output household information in a table 700 that includes a combination of information generated by the householding circuitry 108 of FIG. 1 and information provided by one or more media providers. In the table 700, rows represent devices. For example, a first row 701 is associated with a first device that is associated with provider A (e.g., shown in cell 738) and assigned a global household ID as shown in the third column 716 (e.g., shown in cell 708). The table 700 includes a first column 712, a second column 714, a fifth column 720, and a seventh column 724 that include data that may be provided by a media provider or by another third party data source. In contrast, a third column 716, a fourth column 718, and a sixth column 722 include data that is generated by the example householding circuitry 108 of FIG. 1. The third column 716 is a global household ID column that can be used to identify devices in a household. For example, a first cell 702, a second cell 704, and a third cell 706 all have a global household ID of 1001. Thus, the devices associated with each cell are associated with the same household.

A flowchart representative of example machine readable instructions, which may be executed to configure processor circuitry to implement the householding circuitry 108 of FIG. 1, is show r in FIGS. 8-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or anon-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 8-10, many other methods of implementing the example householding circuitry 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may he stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to deduplicate and household devices. The machine readable instructions and/or the operations 800 of FIG. 8 begin at block 802, at which the data collection circuitry 202 of FIG. 2 retrieves device data. For example, the data collection circuitry 202 of FIG. 2 may collect data from internee service providers (e.g., obtain IP addresses), media providers (e.g., obtain PII). In some examples, the data collection circuitry 202 of FIG. 2 retrieves data from a plurality of service providers, wherein the retrieved data includes duplicate devices. At block 804, the example deduplication circuitry 204 of FIG. 2 deduplicates device data. The operations of block 804 will be described in association with FIG. 9.

Next, at block 806, the example graph generation circuitry 206 of FIG. 2 generates household graph nodes from the deduplicated device data. For example, the graph generation circuitry 206 of FIG. 2 may generate nodes representing devices that will be connected by edges that represent linkages identified between the devices. In some examples, the graph generation circuitry 206 of FIG. 2 may remove nodes that are inconsistent with data collected from an audience measurement entity.

At block 808, the example graph generation circuitry 206 of FIG. 2 connects nodes based on IP address, a common device identification algorithm, and LUIDS. For example, devices that are associated with a single LUID may be householded based on the LUID. In some examples, one or more devices have LUIDs that do not match other LUIDS and the one or more devices remains as a singleton. Some devices may have no LUID. In examples without a LUID, a common devices identification algorithm can be used to identify linkages between the devices.

At block 810, the example connected component circuitry 208 of FIG. 2 performs a connected component analysis on the graph to identify strongly and weakly connected devices in the graph. For example, the connected component circuitry 208 of FIG. 2 may assign a threshold value to each edge in the graph. Edges with values greater than the threshold can be identified as strong connections (e.g., intra-household), while edges with values lesser than the threshold can be identified as weak connections (e.g., inter-household). Finally, at block 812, the example graph pruning circuitry 210 of FIG. 2 prunes the graph to remove inconsistencies. The operations 800 end after block 812.

FIG. 9 is a flowchart representative of example machine readable instructions and/or example operations 804 that may be executed and/or instantiated by processor circuitry to deduplicate device data. The machine readable instructions and/or the operations 804 of FIG. 9 begin at block 902, at which the deduplication circuitry 204 of FIG. 2 retrieves common homes datasets. For example, the graph generation circuitry 206 of FIG. 2 may obtain device data that is placed into one or more tables in a database management system. The database management system may be operated by the deduplication circuitry 204 of FIG. 2.

At block 904, the example deduplication circuitry 204 of FIG. 2 outer joins common home datasets to generate a joined dataset. For example, there may be a plurality of common home tables storing data. The example deduplication circuitry 204 of FIG. 2 may perform an outer join operation on the plurality of tables to generate a single table that includes matched values and unmatched values from the plurality of tables.

At block 906, the example deduplication circuitry 204 of FIG. 2 addresses conflicts in the joined dataset. For example, the deduplication circuitry 204 of FIG. 2 may identify duplicate entries in the dataset that are inconsistent with PII provided by a panelist household. In some examples, conflicts may be identified based on include public records, tax assessor records, motor vehicle information, census data, publication subscription information, credit information, consumer surveys, etc.

At block 908, the example deduplication circuitry 204 of FIG. 2 identifies inactive devices in the joined dataset. For example, the deduplication circuitry 204 of FIG. 2 may retrieve activity data for a first threshold period of time (e.g., a month, a year, etc.). The deduplication circuitry 204 of FIG. 2 may then remove devices that have not been active for a second threshold period (e.g., a minute, an hour, etc.) at block 910. The instructions continue at block 806.

FIG. 10 is a flowchart representative of example machine readable instructions and/or example operations 1000 that may be executed and/or instantiated by processor circuitry to prune a device graph and remove inconsistent nodes and/or edges. At block 1002, the example graph pruning circuitry 210 of FIG. 2 prunes duplicates resulting from a common devices identification algorithm.

At block 1004, the example graph pruning circuitry 210 of FIG. 2 prunes instances with two panelist households in a single addressable household. For example, a first provider device may be matched. through by a common device identification algorithm to a to provider two household and a provider three household. The example graph pruning circuitry 210 of FIG. 2 may prune one or more of the connections between the devices.

At block 1006 the example graph pruning circuitry 210 of FIG. 2 determines if more than one RPD household is included in an addressable household. If not, control moves directly to block 1010. If so, the graph pruning circuitry 210 of FIG. 2 prunes LUIDs and IP addresses associated with the household at block 1008 before control moves to block 1010.

At block 1010 the example graph pruning circuitry 210 of FIG. 2 determines if a panel household contains a device not linked to a panel device. If not, control moves directly to block 1014. If so, the graph pruning circuitry 210 of FIG. 2 prunes LUIDs and IP addresses associated with household at block 1012 before control moves to block 1014.

At block 1014 the example graph pruning circuitry 210 of FIG. 2 determines if a component contains more than one LUID. If not, control moves directly to block 1018. If so, the graph pruning circuitry 210 of FIG. 2 prunes all LUIDS associated with the component at block 1016 before control moves to block 1018.

At block 1018 the example graph pruning circuitry 210 of FIG. 2 determines if a residential household contains RPD or meter data and exceeds a threshold number of smart TVs. If not, the instructions end. If so, the graph pruning circuitry 210 of FIG. 2 drops LUIDs and IPs associated with the identified household before the instructions end.

FIG. 11 is a block diagram of an example processor platform 1100 structured to execute and/or instantiate the machine readable instructions and/or the operations of FIGS. 8-10 to implement the householding circuitry 108 of FIGS.1-6. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example data collection circuitry 202, the example deduplication circuitry 204, the example graph generation circuitry 206, the example connected component circuitry 208, the example graph pruning circuitry 210, the example data storage circuitry 212.

The processor circuitry 1112 of the illustrated example includes a local memory 1113 (e.g., a cache, registers, etc). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIGS. 8-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 4. In this example, the processor circuitry 1112 of FIG. 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowchart of FIGS. 8-10 to effectively instantiate the circuitry of FIG. 2 as logic circuits to perform the operations corresponding to those machine readable instructions. In some such examples, the circuitry of FIG. 2 is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowchart of FIGS. 8-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206 Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store limit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a hank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented, by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12. executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowchart of FIGS. 8-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowchart of FIGS, 8-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 8-10. As such, the FPGA circuitry 1300 may be structured to effectively instantiate some or all of the machine readable instructions of the flowchart of FIGS. 8-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 8-10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented 1w the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 8-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modem FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 8-10 may be executed by one or more of the cores 1202 of FIG. 12, a second portion of the machine readable instructions represented by the flowcharts of FIGS, 8-10 may be executed by the FPGA circuitry 1300 of FIG. 13, and/or a third portion of the machine readable instructions represented by the flowcharts of FIGS. 8-10 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example. the XPU may include a CPU in one package, a DSP in another package, a GPU in yet another package, and an FPGA in still yet another package.

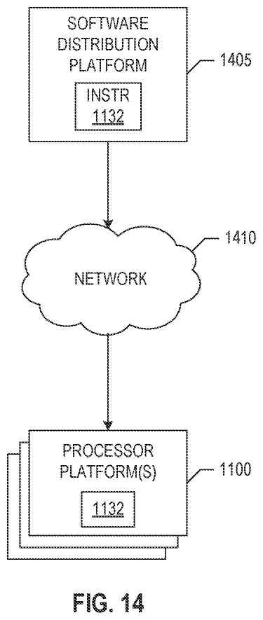

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11 The third parties may be consumers, users, retailers, OEMs, etc. who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 800 of FIGS. 8-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 1132 of FIG. 11, may be downloaded to the example processor platform 1100, which is to execute the machine readable instructions 1132 to implement the householding circuitry 108 of FIG. 2. In some examples, one or more servers of the software distribution platform 1405 periodically otter, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that household and deduplicate media devices. Disclosed systems, methods, apparatus, and articles of manufacture improve the efficiency of using a computing device by providing a comprehensive, flexible, and robust solution for householding and deduplication based on directly measured information that identifies households, detailed behavioral data from linear TV tuning, and additional sources of information depending on availability (e.g., 3rd party IDs, IP addresses, geolocation, etc). Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to household and deduplicate media devices are disclosed herein. Further examples and combinations thereof include the following:

Example 1 includes an apparatus comprising at least one memory, instructions, and processor circuitry to execute the instructions to deduplicate at least one of panel data, automatic content recognition data, or return path data to generate a deduplicated data set, generate a graph that connects devices identified in the deduplicated data set, the devices connected based on at least one of a shared interact protocol addresses, a shared location identifier, or a common device identifier assigned by a common device identification algorithm, remove one or more connections based on an inconsistency between the one or more connections and personally identifiable information.

Example 2 includes the apparatus of any of the previous examples, wherein the processor circuitry is to identify a segment of the graph including devices of a single household.

Example 3 includes the apparatus of any of the previous examples, wherein the processor circuitry is to identify the segment based on a connected component analysis that assigns quality values to connections of the graph.

Example 4 includes the apparatus of any of the previous examples, wherein the processor circuitry is to identify connections of the graph with quality values greater than a threshold value as intra-household connections, and wherein the quality values less than the threshold value are identified as inter-household connections.

Example 5 includes the apparatus of any of the previous examples, wherein the at least one of panel data, the automatic content recognition data, or the return path data is obtained from at least two different providers.

Example 6 includes the apparatus of any of the previous examples, wherein the processor circuitry is to remove a first one of the devices from the graph that is identified as inactive.

Example 7 includes the apparatus of any of the previous examples, wherein the processor circuitry is to reconstruct the graph after the first one of the devices is removed from the graph.

Example 8 includes a non-transitory machine readable storage medium comprising instructions which, when executed by processor circuitry, cause the processor circuitry to deduplicate at least one of panel data, automatic content recognition data, or return path data to generate a deduplicated data set, generate a graph that connects devices identified in the deduplicated data set, the devices connected based on at least one of a shared internet protocol addresses, a shared location identifier, or a common device identifier assigned by a common device identification algorithm, remove one or more connections based on an inconsistency between the one or more connections and personally identifiable information.

Example 9 includes the computer readable medium of any of the previous examples, wherein the instructions, when executed, cause the processor circuitry to identify a segment of the graph including devices of a single household.

Example 10 includes the machine readable medium of any of the previous examples, wherein the instructions, when executed, cause the processor circuitry to identify the segment based on a connected component analysis that assigns quality values to connections of the graph.

Example 11 includes the machine readable medium of any of the previous examples, wherein the instructions, when executed, cause the processor circuitry to identify connections of the graph with quality values greater than a threshold value as intra-household connections, and wherein the quality values less than the threshold value are identified as inter-household connections.

Example 12 includes the machine readable medium of example 8, wherein the at least one of panel data, the automatic content recognition data, or the return path data is obtained from at least two different providers.

Example 13 includes the machine readable medium of any of the previous examples, wherein the instructions, when executed, cause the processor circuitry to remove a first one of the devices from the graph that is identified as inactive.

Example 14 includes the machine readable medium of any of the previous examples, wherein the instructions, when executed, cause the processor circuitry to reconstruct the graph after the first one of the devices is removed from the graph.

In any of the previous examples, the machine readable medium may be a non-transitory machine readable medium.

Example 15 includes a method comprising deduplicating, by executing an instruction with processor circuitry, at least one of panel data, automatic content recognition data, or return path data to generate a deduplicated data set, generating, by executing an instruction swish the processor circuitry, a graph that connects devices identified in the deduplicated data set, the devices connected based on at least one of a shared internet protocol addresses, a shared location identifier, or a common device identifier assigned by a common device identification algorithm, removing, by executing an instruction with processor circuitry, one or more connections based on an inconsistency between the one or more connections and personally identifiable information.

Example 16 includes the method of any of the previous examples, further including identifying a segment of the graph including devices of a single household.

Example 17 includes the method of any of the previous examples, further including identifying the segment based on a connected component analysis that assigns quality values to connections of the graph.

Example 18 includes the method of any of the previous examples, further including identifying connections of the graph with quality values greater than a threshold value as intra-household connections, and wherein the quality values less than the threshold value are identified as inter-household connections.

Example 19 includes the method of any of the previous examples, wherein the at least one of panel data, the automatic content recognition data, or the return path data is obtained from at least two different providers.

Example 20 includes the method of any of the previous examples, further including removing a first one of the devices from the graph that is identified as inactive.

Example 21 includes the method of any of the previous examples, further including reconstructing the graph after the first one of the devices is removed from the graph.

Example 22 includes an apparatus comprising means for deduplicating at least one of panel data, automatic content recognition data, or return path data to generate a deduplicated data set, means for generating a graph that connects devices identified in the deduplicated data set, the devices connected based on at least one of a shared internet protocol addresses, a shared location identifier, or a common device identifier assigned by a common device identification algorithm, and means fix removing one or more connections based on an inconsistency between the one or more connections and personally identifiable information.

Example 23 includes the method of any of the previous examples, further including means for identifying a segment of a graph based on a connected component analysis that assigns a quality value to a connection of the graph.

Example 24 includes the method of any of the previous examples wherein the means for removing one or more connections is to remove a first one of the devices from the graph that is identified as inactive.

Example 25 includes the method of any of the previous examples, wherein the means for generating the graph are to reconstruct the graph after the first one of the devices is removed from the graph.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
instructions; and
processor circuitry to execute the instructions to:
deduplicate at least one of panel data, automatic content recognition data, or return path data to generate a deduplicated data set;
generate a graph that connects devices identified in the deduplicated data set, the devices connected based on at least one of a shared internet protocol addresses, a shared location identifier, or a common device identifier assigned by a common device identification algorithm; and
remove one or more connections based on an inconsistency between the one or more connections and personally identifiable information.

2. The apparatus of claim 1, wherein the processor circuitry is to identify a segment of the graph including devices identified in the deduplicated data set that are associated with a single household.

3. The apparatus of claim 2, wherein the processor circuitry is to identify the segment based on a connected component analysis that assigns quality values to connections of the graph.

4. The apparatus of claim 3, wherein the processor circuitry is to identify connections of the graph with quality values greater than a threshold value as intra-household connections, and wherein quality values less than the threshold value are identified as inter-household connections.

5. The apparatus of claim 1, wherein the at least one of panel data, the automatic content recognition data, or the return path data is obtained from at least two different providers.

6. The apparatus of claim 1, wherein the processor circuitry is to remove a first one of the devices from the graph that is identified as inactive.

7. The apparatus of claim 6, wherein the processor circuitry is to reconstruct the graph after the first one of the devices is removed from the graph.

8. A non-transitory machine readable storage medium comprising instructions which, when executed by processor circuitry, cause the processor circuitry to:
deduplicate at least one of panel data, automatic content recognition data, or return path data to generate a deduplicated data set;
generate a graph that connects devices identified in the deduplicated data set, the devices connected based on at least one of a shared internet protocol addresses, a shared location identifier, or a common device identifier assigned by a common device identification algorithm; and
remove one or more connections based on an inconsistency between the one or more connections and personally identifiable information.

9. The non-transitory machine readable medium of claim 8, wherein the instructions, when executed, cause the processor circuitry to identify a segment of the graph including devices identified in the deduplicated data set that are associated with a single household.

10. The non-transitory machine readable medium of claim 9, wherein the instructions, when executed, cause the processor circuitry to identify the segment based on a connected component analysis that assigns quality values to connections of the graph.

11. The non-transitory machine readable medium of claim 10, wherein the instructions, when executed, cause the processor circuitry to identify connections of the graph with quality values greater than a threshold value as intra-household connections, and wherein quality values less than the threshold value are identified as inter-household connections.

12. The non-transitory machine readable medium of claim 8, wherein the at least one of panel data, the automatic content recognition data, or the return path data is obtained from at least two different providers.

13. The non-transitory machine readable medium of claim 8, wherein the instructions, when executed, cause the processor circuitry to remove a first one of the devices from the graph that is identified as inactive.

14. The non-transitory machine readable medium of claim 13, wherein the instructions, when executed, cause the processor circuitry to reconstruct the graph after the first one of the devices is removed from the graph.

15. A method comprising:
deduplicating, by executing an instruction with processor circuitry, at least one of panel data, automatic content recognition data, or return path data to generate a deduplicated data set;
generating, by executing an instruction with the processor circuitry, a graph that connects devices identified in the deduplicated data set, the devices connected based on at least one of a shared internet protocol addresses, a shared location identifier, or a common device identifier assigned by a common device identification algorithm; and
removing, by executing an instruction with processor circuitry, one or more connections based on an inconsistency between the one or more connections and personally identifiable information.

16. The method of claim 15, further including identifying a segment of the graph including devices identified in the deduplicated data set that are associated with a single household.

17. The method of claim 16, further including identifying the segment based on a connected component analysis that assigns quality values to connections of the graph.

18. The method of claim 17, further including identifying connections of the graph with quality values greater than a threshold value as intra-household connections, and wherein the quality values less than the threshold value are identified as inter-household connections.

19. The method of claim 15, wherein the at least one of panel data, the automatic content recognition data, or the return path data is obtained from at least two different providers.

20. The method of claim 15, further including removing a first one of the devices from the graph that is identified as inactive.

21-25. (canceled)
